(19) United States
(12) Patent Application Publication
(10) Pub. No.: US 2010/0015819 A1
(43) Pub. Date: Jan. 21, 2010

(54) Power Supply Connection Apparatus

(76) Inventor: Vittorio Antonio Tedeschi, Queensland (AU)

Correspondence Address: CATALYST LAW GROUP, APC, 9710 SCRANTON ROAD, SUITE S-170, SAN DIEGO, CA, 92121, US

(21) Appl. No.: 11/719,849

(22) PCT Filed: Nov. 23, 2005
(86) PCT No.: PCT/AU05/01778

§ 371 Date: Mar. 31, 2009

(30) Foreign Application Priority Data
Nov. 23, 2004 (AU) 2004907404
Apr. 29, 2005 (AU) 2005902154
Jun. 3, 2005 (AU) 2005902876

(51) Int. Cl. H01R 39/00

(52) U.S. Cl. 439/13

(57) ABSTRACT

A power supply connection apparatus (10) including a housing (11) having at least one first contact member (12) in communication with a power supply, at least one rotary member (13) mounted for rotation relative to said housing, the rotary member including at least one second contact member (14), the rotary member operably movable between a first condition to align the respective contact members and a second condition in which the contact members are not aligned.

### FIELD OF THE INVENTION

The present invention relates to power supply sockets and in particular to power supply sockets that offer enhanced safety to users and third parties.

### BACKGROUND ART

Electricity sockets are commonly available and come in a wide variety of forms. Perhaps the most commonly seen electricity sockets are the wall-mounted sockets that allow a user to access the mains power supply for electrically powered accessories such as kitchen equipment, vacuum cleaners and whitegoods.

These wall sockets generally include a backing plate with the electrical contacts and connecting by wiring to the mains power supply and they also have a cover member to cover the attachment means. The backing plate has a plurality of openings in which the electrical contacts are located and which receive the tines of the power plug of the apparatus. When the plug is inserted into the socket, the contacts engage the tines but the power generally does not flow until a switch is activated.

One problem with the wall mounted sockets is that if a small elongate conductive member is inserted into the openings in the socket, the power can flow regardless of whether or not the switch has been activated. This is a widely recognized problem and many solutions have been proposed in the past. Generally these solutions relate to preventing the insertion of the conductive member into the openings by providing covers or similar for the openings or the socket in general.

Similar problems are encountered when using power boards and the like which allow multiple power plugs to be used with a single power outlet.

For many years, the power point has been a device attached to the wall with electrical currents freely available with the flick of a switch. This makes it an inviting target for children to stick objects into its holes. Also another problem with age and continued use, the switches tend to break allowing electrical current to flow into the switch which will cause an electric shock.

Further, the provision of switches to allow and prevent the flow of electricity to the socket do not always completely isolate the power flow from the electrical contacts. The switches themselves also make the outlets less aesthetically pleasing.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a power supply socket apparatus which may at least partially overcome at least one of the abovementioned disadvantages or provide the consumer with a useful or commercial choice.

In one form, the invention resides in a power supply connection apparatus including a housing having at least one first contact member in communication with a power supply, at least one rotary member mounted for rotation relative to said housing, the rotary member including at least one second contact member, the rotary member operably movable between a first condition to align the respective contact members and a second condition in which the respective contact members are not aligned.

The connection apparatus may have a socket (female) or plug (male) configuration or both, with a socket associated with either the at least one first contact member or the at least one second contact member and a plug associated with the other of the at least one first contact member or the at least one second contact member.

The power supply socket apparatus of the present invention will preferably be available in different configurations including single socket, double socket and four socket configurations. In fact, there may be any number of sockets provided in a single housing. Where the apparatus is provided in multiple rotating socket member configuration, more than one rotary socket member may be associated with a single power supply.

The power supply socket apparatus of the invention may be provided as a wall mounted apparatus, for example as a permanent fitting such as a “power point” or alternatively in a portable configuration, for example as a power board or the like.

When provided in the portable configuration, the power supply socket apparatus will generally have multiple sockets in a single housing which can be linked to a mains power supply by a single plug and socket. The power supply socket apparatus of the invention may also find application as the female or socket end of electrical extension lead or the like.

The power supply socket apparatus includes a housing. The housing will typically be formed of an electrically non-conductive material and a good example of a material is a plastic material. The plastic material may be rigid or flexible as required but will generally be substantially rigid or at least dimensionally stable. The housing will be shaped according to its application, for example a wall outlet housing will generally be flatter whereas an electrical extension lead female end will generally be shaped to allow manipulation by a user's hand and will therefore be more bulbous.

There will typically be more than one first contact member and more than one second contact member and most suitably, each will include a set of contact members.

The power supply socket apparatus preferably includes a first set of contact members in communication with a power supply, the contact members typically being electrical contact members. The at least one first contact member is associated with the housing and will generally be located within the housing. There will generally be at least a pair of contact members. The number and configuration of the contact members will generally be determined according to the configuration required by the governing body of the country in which the power supply socket apparatus is sold or used. For example, Australia uses a Type I, three pin electrical socket. The Type I plug has three pins, namely a lower, substantially vertical “earth” pin and a pair of upper angled pins, one designated an “active” pin and the other, a “neutral” pin. Plugs are sold in Australia which lack the “earth” pin. There are therefore, three contact members in a Type I plug and three corresponding contact members in a Type I socket. There are however many different types of plug and socket configurations (at least Types A to M) and the contact configuration will vary accordingly.

The at least one first contact member will typically be associated with at least one fuse. The fuse is generally located within the housing and is designed to disrupt the power supply in the case of a power surge to reduce the risk of appliances suffering damage particularly by electrical fusion.

The at least one first contact member is preferably located in the housing of the power supply socket apparatus. The contact will typically be in electrical communication with a power supply, generally a mains power supply, however an alternative embodiment of the invention may provide for the use of portable backup power supply.

The housing of the power supply socket apparatus generally has an opening into which the rotary member fits and the at least one first contact member will generally extend to communicate with the opening. Preferably, the at least one first contact is accessible via the open in the housing.

The power supply socket apparatus of the present invention further includes at least one rotary member mounted for rotation relative to said housing. Typically, the rotary member will be removably attachable relative to the housing by insertion into the opening in the housing. The rotary member may be changeable to allow sockets of different configurations to be used with the apparatus.

The rotary member will generally be or include a socket configuration to match the plug configuration of the country in which it is sold or used. The rotary member will therefore typically be adapted to receive the pin or pins of a power plug therein. The rotary member will preferably include openings therein to receive pins of a plug therein.

The number and configuration of the openings will be provided according to the outlet configuration in different countries as discussed above.

The rotary member is generally manufactured of all electrically non-conductive material such as a plastic material.

The at least one second contact is preferably associated with at least some of the openings in the rotary member. Again for example, the Australian Type I system uses at least two pins, the “active” pin and the “neutral” pin. In this case, the second set of contacts will typically be a pair of contacts, one for each of the “active” pin and the “neutral” pin. The at least one second contact will typically be in electrical communication with the pins of the plug when the plug is fully inserted into the openings in the rotary member. The at least one second contact is typically also adapted to be aligned with the first set of contacts upon rotation of the rotary member.

There will generally be a rotation prevention means to prevent over-rotation of the rotary member and to assist with the alignment of the respective contacts following rotation. There may be more than one rotation prevention means, one to prevent over-rotation of the rotary member in either direction.

The rotary member is operably movable between a first condition to align the respective sets of contact members and a second condition in which the respective sets of contact members are not aligned. The first condition is generally the “on” condition where power can flow from the power supply, through the aligned contact members and to the appliance. The second condition is generally the “off” condition where power cannot flow to the appliance and further, is not even available to the at least one second contact member due to the position of the rotary member and the material of construction of the rotary member isolating the at least one first contact member from the at least one second contact member.

There will also generally be a locking arrangement to temporarily lock the rotary member in the “on” condition. The locking arrangement will typically include a shaped portion on the rotary member and a correspondingly shaped portion on the housing. The locking arrangement will suitably maintain the rotary member in the “on” condition until either the power plug pins are removed from the openings causing the auto-rotation to the “off” condition or until a user rotates the rotary member to the “off” condition manually.

The apparatus of the present invention may suitably further include a biasing means to bias the rotary member into an “off” position where the respective contact members are isolated from one another.

Preferably, removal of the power plug pins from the openings in the rotating member causes the rotary member to auto-rotate to the “off” condition. Therefore, means to register that the pins of the plug are in the correct position in the openings in the rotary member may typically be provided. The means to register the presence of the pins of the plug may be configured such that even partial removal of the pins from the openings may be sufficient to cause the auto-rotation to the “off” condition. The registration means may preferably be located at or adjacent to the base of at least one of the openings in the rotary member which receives the pins. Alternatively, the registration means may be provided on an outer face of the rotary member such that pressure from the plug body may be required to prevent auto-rotation.

The apparatus of the present invention may suitably further include one or more cover members which are removably engageable with the housing and/or the rotary member to enable a user to choose an aesthetically pleasing colour or pattern or combination for the apparatus.

Preferably, the cover members may be changeable so that a user can change the cover members quickly and easily. The cover members may therefore have a click-fit or snap-fit arrangement with the housing and/or rotary members. Typically, each rotary member may have a cover member as may the housing.

Another preferably additional feature is the backup power pack which may be associated with the power supply socket apparatus of the invention. This backup power pack may be removably attachable to the apparatus of the present invention and preferably allows the apparatus to provide backup power to an appliance in case of power disruption. If the power is cut off, the apparatus of the present invention may be manually switchable to draw power from the backup supply to allow for a period of operation. The power supply may also switch automatically.

When the mains power supply is available, the apparatus may be switchable (either manually or automatically) to the mains power supply. The backup power pack may then recharge automatically to be readily available in the next disruption. Typically, the backup power pack will supply power to the at least one first contact member. The backup power pack will typically include a reservoir or storage means for storing an electrical charge, typically in the form of one or more batteries.

Whilst the present invention has been described according to a preferred embodiment of an electrical connection socket apparatus, it is to be anticipated that the particular features of the invention may be easily adapted to other plug and socket arrangements where a flowing media is present and connections such as hydraulic hoses or the like are used.

In another form therefore, the invention may reside in a connection apparatus including a housing with an inlet adapted for communication with a flowing media supply, at least one rotary member mounted for rotation relative to said housing, the rotary member including an outlet attachable to a connection portion of a flow means along which the flowing media may flow, the rotary member operably movable between a first condition to allow flow of the media through the apparatus and a second condition in which flow is prevented.

According to an alternative preferred embodiment, a heat sensor may be incorporated into the apparatus. The apparatus may also be provided with an alert mechanism. Preferably, the heat sensor may be associated with both the alert mechanism and the rotary member (or the locking arrangement) such that when the heat sensor registers a heat rise above a predetermined level, such as that occurring during a fire or similar, the alert mechanism may be activated and the rotary member may auto-rotate to the “off” condition effectively disabling the electrical supply to any devices which may be connected to the apparatus.

The apparatus may also be provided with a reset switch or other means to reset the apparatus after disabling in this manner has occurred.

The heat sensor and alert mechanism may be powered from the power source to which the power supply socket apparatus is connected. This will usually be a mains power supply. There may also be a backup power supply, for example a battery power supply for instances where the mains supply is unavailable.

The heat sensor and alert mechanism may be adapted to communicate with similar means provided in other power supply socket apparatus provided in the same building but in a different location. This may allow the disablement of all power supply socket apparatus in a building if one of the heat sensors and alert mechanisms is activated. This may be useful, in a situation where a house has multiple power supply socket apparatus, and the alert mechanism of one of which is activated by the heat sensor, indicating a fire in one room. The activated heat sensor may then communicate to all other power supply socket apparatus in the house, disabling all of them. The communication may be along physical means such as a cable or similar or wireless. Alternatively, the heat sensor and alert mechanism may be slaved to a fire suppression system such that activation of the heat sensor and the alert mechanism may also activate the fire suppression system.

### BRIEF DESCRIPTION OF THE DRAWINGS

Various embodiments of the invention will be described with reference to the following drawings, in which:

FIG. 1 is a plan view of a power supply socket apparatus according to a preferred embodiment of the present invention with the cover member removed and in the “off” condition.

FIG. 2 is a plan view of the power supply socket apparatus as illustrated in FIG. 1 with the cover member in place.

FIG. 3 is a plan view of a power supply socket apparatus according to a preferred embodiment of the present invention with the cover member removed and in the “on” condition.

FIG. 4 is a plan view of the power supply socket apparatus as illustrated in FIG. 3 with the cover member in place.

FIG. 5 is a plan view of a power supply socket apparatus in a twin socket configuration with the cover member removed and in the “on” condition.

FIG. 6 is a plan view of a power supply socket apparatus as illustrated in FIG. 5 with the cover member removed and in the “off” condition.

FIG. 7 is a stepwise illustration of a process for changing the visual appearance of a four way socket configuration of the present invention by changing the cover plate and sockets.

FIG. 8 is a plan view of a power supply socket apparatus in a twin configuration with a backup power supply associated therewith.

FIG. 9 is a rear elevation view of a power supply socket apparatus according to an alternative embodiment with a heat sensor incorporated.

FIG. 10 is a side view of the power supply socket apparatus illustrated in FIG. 9.

FIG. 11 is a front view of the power supply socket apparatus illustrated in FIG. 9.

### DETAILED DESCRIPTION OF THE PREFERRED EMBODIMENT

According to a preferred embodiment of the present invention, a power supply socket apparatus 10 is provided.

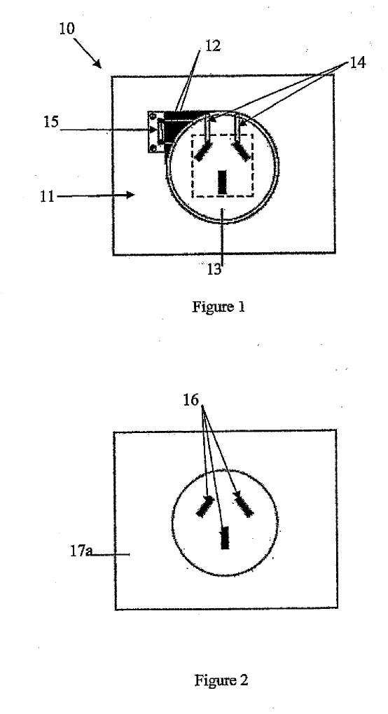

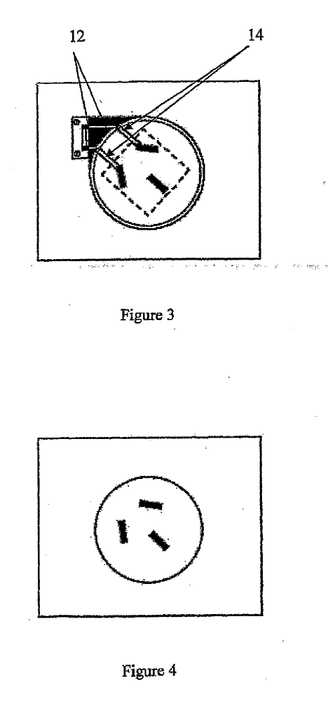

The power supply socket apparatus 10 illustrated in FIGS. 1 to 4 is the simplest configuration having only a single socket. The apparatus 10 has a housing 11 with a set of first contact members 12 which are in communication with a power supply (not shown). There is also a rotary member 13 mounted for rotation relative to said housing 11. The rotary member 13 has a set of second contact members 14, and movement of the rotary member 13 between a first condition aligns the respective contact members allowing power to flow as illustrated in FIGS. 3 and 4. Movement of the rotary member 13 in the opposite direction activates a second condition in which the respective contact members are not aligned as in FIGS. 1 and 2.

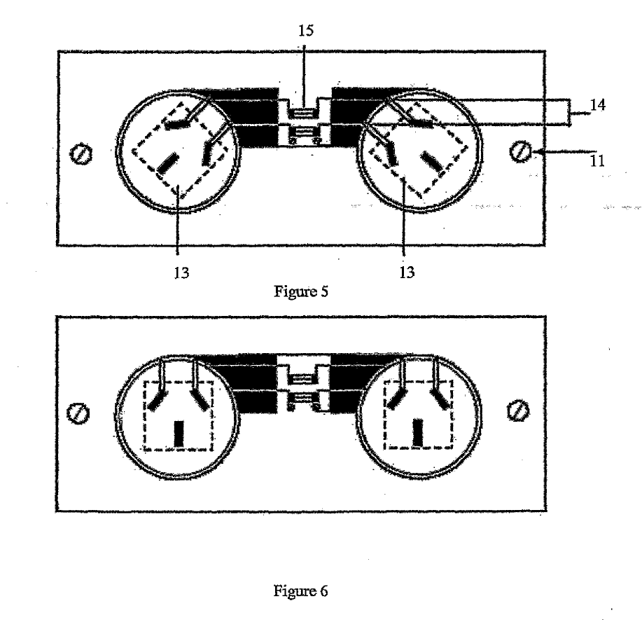

A double socket configuration is illustrated in FIGS. 5 and 6.

The housing 11 of the apparatus is formed of a plastic material. The plastic material is generally rigid. The housing 11 is shaped according to its application, for example a wall outlet housing as illustrated in the Figures will generally be flatter whereas an electrical extension lead female end will generally be shaped to allow manipulation by a user's hand and will therefore be more bulbous.

The power supply socket apparatus 10 includes a first set of electrical contact members 12 in communication with a power supply (not shown).

As discussed above, the number and configuration of the contact members will generally be determined according to the configuration required by the governing body of the country in which the power supply socket apparatus is sold or used. For example, Australia uses a Type I, three pin electrical socket. The Type I plug has three pins, namely a lower, substantially vertical “earth” pin, and a pair of upper angled pins, one designated an “active” pin and the other, a “neutral” pin. There are therefore, three contact members in a Type I plug and three corresponding contact members in a Type I socket. There are however many different types of plug and socket configurations (at least Types A to M) and the contact configuration will vary accordingly.

The set of first contact members 12 is associated with a fuse 15. The fuse 15 is located within the housing 11 and is designed to disrupt the power supply in the case of a power surge to reduce the risk of appliances suffering damage.

The power supply socket apparatus of the present invention further includes at least one rotary member 13 mounted for rotation relative to the housing 11. The rotary member 13 is removably attachable relative to the housing 11 by insertion into an opening (not shown) in the housing 11.

The rotary member 13 has a socket configuration to match the plug configuration of the country in which it is sold or used. The rotary member 13 includes openings 16 therein to receive pins of a plug (not shown) therein.

The number and configuration of the openings 16 will be provided according to the outlet configuration in different countries as discussed above.

The rotary member 13 is manufactured of an electrically non-conductive material such as a plastic material.

The set of second contact members 14 is associated with the openings 16 in the rotary member 13. Again for example, the Australian Type I system uses at least two pins, the “active” pin and the “neutral” pin. In this case, the second set of contacts will be a pair of contacts, one for each of the “active” pin and the “neutral” pin. The set of second contact members 14 is in electrical communication with the pins of the plug when the plug is fully inserted into the openings in the rotary member 13. The set of second contact members 14 is also adapted to be aligned with the first set of contact members 12 upon rotation of the rotary member 13.

Removal of the power plug pins from the openings 16 in the rotating member 13 causes the rotary member 13 to auto-rotate to the “off” condition. Means to register that the pins of the plug are in the correct position in the openings 16 in the rotary member 13 are provided but not illustrated. The means to register the presence of the pins of the plug are configured such that even partial removal of the pins from the openings 16 is sufficient to cause the auto-rotation to the “off” condition.

The apparatus 10 of the present invention is provided with cover members 17a, 17b which are removably engageable with the housing 11 and the rotary member 13 to enable a user to choose an aesthetically pleasing colour or pattern or combination for the apparatus 10.

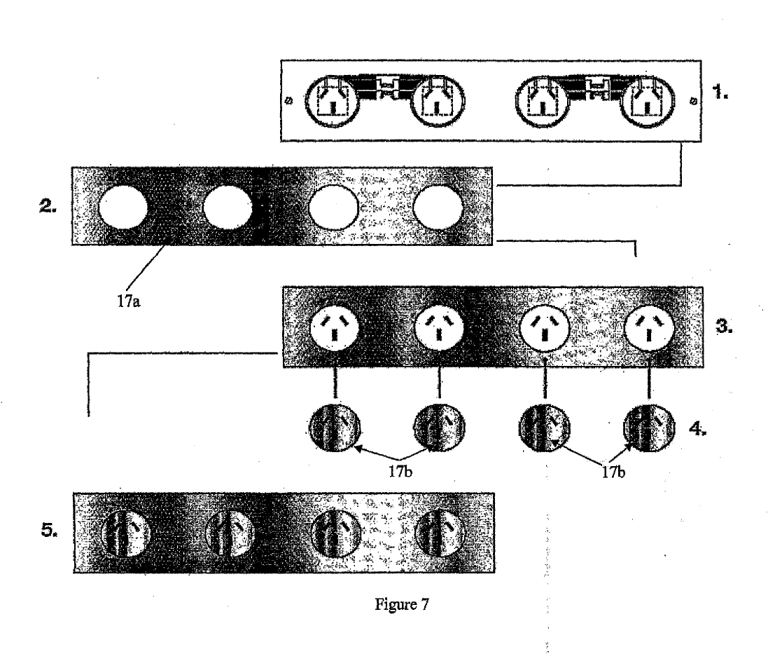

Illustrated in FIG. 7 is a stepwise method for changing the cover members 17a, 17b of the apparatus 10. FIG. 7.1 illustrates the apparatus 10 with the cover members 17a, 17b for both the housing 11 and each of the rotary members 13 removed. FIG. 7.2 illustrates the cover member 17a for the housing 11. In FIG. 7.3, the cover member 17a for the housing 11 has been fitted over the housing 11 and is attached thereto by a snap-fit arrangement. The individual rotary member cover members 17b illustrated in FIG. 7.4 are then fitted to the rotary members 13 forming the “finished” apparatus 10 in FIG. 7.5.

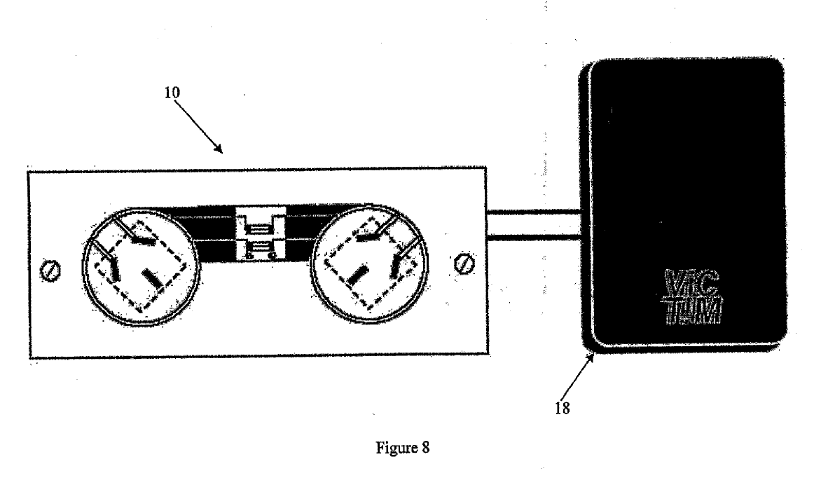

Illustrated in FIG. 8 is the apparatus 10 of the present invention attached to a backup power pack 18. The backup power pack 18 is removably attachable to the apparatus 10 of the present invention and provides backup power, though the apparatus of the invention, to an appliance in case of power disruption. If the power is cut off, the apparatus 10 of the present invention is switchable to draw power from the backup power pack 18 to allow for a period of operation.

When the mains power supply is available, the apparatus 10 is switchable (either many or automatically) to the mains power supply. The backup power pack 18 then recharges automatically to be readily available in the next disruption.

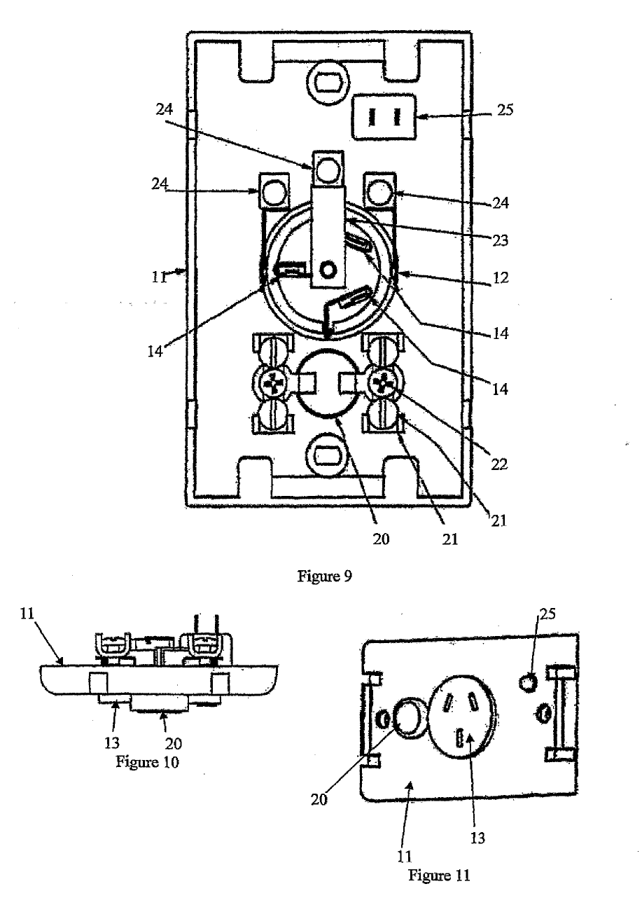

Illustrated in FIG. 9 to 11 is an alternative embodiment of the present invention incorporating a heat sensor 20 and alert mechanism. The heat sensor is provided in the housing and stands slightly proud of the housing surface as seen in FIGS. 10 and 11. The heat sensor 20 is provided with electrical power through a system of contacts 21 which are maintained in place using screws 22. The heat sensor is associated with the socket 13 which is provided with a plurality second contact members 14. The socket 13 is retained relative to the housing using a mounting portion 23 to which the socket 13 is mounted to allow rotation. The mounting portion is attached to a rear side of the housing at amounting point 24.

The housing is provided with a plurality of first contact members 12 which are also mounted relative to the housing by respective mounting portions 24. The apparatus of this form of the invention is provided with a reset switch 25 to reset the apparatus after activation of the heat sensor 30 and the alert mechanism.

The heat sensor 20 is associated with both the alert mechanism and the rotary socket 13 (or the locking arrangement) such that when the heat sensor 20 registers a heat rise above a predetermined level, such as that occurring during a fire or similar, the alert mechanism is activated and the rotary member 13 auto-rotates to the “off” condition effectively disabling the electrical supply to any devices which may be connected to the apparatus 10.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

1. A power supply connection apparatus including a housing having at least one first contact member in communication with a power supply, at least one rotary member mounted for rotation relative to said housing, the rotary member including at least one second contact member, the rotary member operably movable between a first condition to align the respective contact members and a second condition in which the respective contact members are not aligned.

2. A power supply connection apparatus according to claim 1 wherein the at least one rotary member is provided with at least one electrical connection socket for receiving an electrical connection plug at least partly therein.

3. A power supply connection apparatus according to claim 1 wherein the at least one rotary member is provided with at least one electrical connection plug for engaging an electrical connection socket.

4. A power supply connection apparatus according to claim 1 wherein the at least one first contact member is associated with at least one fuse to disrupt the power supply in the case of a power surge.

5. A power supply connection apparatus according to claim 1 including a backup power pack associated with the power supply socket apparatus of the invention.

6. A power supply connection apparatus according to claim 1 wherein the housing has an opening for each at least one rotary member which is removably attachable relative to the housing by insertion into the opening in the housing.

7. A power supply connection apparatus according to claim 1 including at least one rotation prevention means to prevent over-rotation of the at least one rotary member and to assist with the alignment of the respective contacts following rotation.

8. A power supply connection apparatus according to claim 1 including a locking mechanism to temporarily lock the rotary member in the first condition.

9. A power supply connection apparatus according to claim 1 further including a biasing means to bias the rotary member into the second condition.

10. A power supply connection apparatus according to claim 2 including registration means to detect the removal of the electrical connection plug from the electrical connection socket in the rotating member which causes the rotary member to auto-rotate to the second condition.

11. A power supply connection apparatus according to claim 3 including registration means to detect the removal of the electrical connection plug from the electrical connection socket which causes the rotary member to auto-rotate to the second condition.

12. A power supply connection apparatus according to claim 1 further including heat sensor with an alert mechanism such that when the heat sensor registers a heat rise above a predetermined level, the alert mechanism is activated and the rotary member auto-rotates to the second condition effectively disabling the electrical supply to any devices which may be connected to the apparatus.

13. A connection apparatus including a housing with an inlet adapted for communication with a flowing media supply, at least one rotary member mounted for rotation relative to said housing, the rotary member including an outlet attachable to a connection portion of a flow means along which the flowing media may flow, the rotary member operably movable between a first condition to allow flow of the media through the apparatus and a second condition in which flow is prevented.
